(19) United States
(12) Patent Application Publication
(10) Pub. No.: US 2026/0245923 A1
(43) Pub. Date: Aug. 20, 2026

(54) FUEL CELL DEVICE

(71) Applicant: HONDA MOTOR CO., LTD., TOKYO (JP)

(72) Inventors: Koichi KUROSAWA, WAKO-SHI (JP); Yoshihiro TAMAI, WAKO-SHI (JP); Hirotaka KAJIMAE, WAKO-SHI (JP); Mana YAKABE, WAKO-SHI (JP)

(21) Appl. No.: 19/542,783

(22) Filed: Feb. 18, 2026

(30) Foreign Application Priority Data
Feb. 18, 2025 (JP) 2025-024026

(51) Int. Cl. H01M 8/04029; H01M 8/04007

(52) U.S. Cl. CPC H01M 8/04029; H01M 8/04074

(57) ABSTRACT

A fuel cell device includes a cooling device for circulating a coolant through a fuel cell stack. The cooling device includes: a coolant pump including a pump case that covers a pump main body, and a first connection pipe portion protruding from the pump case; and a valve including a valve case that covers a valve main body, and a second connection pipe portion protruding from the valve case. A coolant flow path is formed by directly connecting the second connection pipe portion to the first connection pipe portion.

### CROSS-REFERENCE TO RELATED APPLICATIONS

This application is based upon and claims the benefit of priority from Japanese Patent Application No. 2025-024026 filed on February 18, 2025, the contents of which are incorporated herein by reference.

### BACKGROUND OF THE INVENTION

### FIELD OF THE INVENTION

The present disclosure relates to a fuel cell device.

### DESCRIPTION OF THE RELATED ART

In recent years, research and development has been conducted on fuel cell devices that contribute to energy efficiency in order to ensure that more people have access to affordable, reliable, sustainable and modern energy.

JP 2022-146446 A discloses a configuration in which a coolant supply pipe and a coolant discharge pipe are connected to a fuel cell stack.

### SUMMARY OF THE INVENTION

There has been a demand for a more satisfactory fuel cell device.

The present disclosure has the object of solving the above-described problem.

An aspect of the present disclosure is characterized by a fuel cell device comprising a cooling device configured to circulate a coolant through a fuel cell stack, wherein the cooling device includes: a coolant pump including a pump case configured to cover a pump main body, and a first connection pipe portion protruding from the pump case; and a valve including a valve case configured to cover a valve main body, and a second connection pipe portion protruding from the valve case, and a coolant flow path is formed by directly connecting the second connection pipe portion to the first connection pipe portion.

According to the present disclosure, a more satisfactory fuel cell device can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an exploded perspective view of a fuel cell device according to an embodiment of the present disclosure;

FIG. 2 is a partially omitted cross-sectional view of the fuel cell device;

FIG. 3 is a bottom view of the fuel cell device;

FIG. 4 is a cross-sectional view taken along line IV-IV of FIG. 2; and

FIG. 5 is a schematic view of the fuel cell device.

### DETAILED DESCRIPTION OF THE INVENTION

A fuel cell device is provided with a cooling device for circulating a coolant through a fuel cell stack. The cooling device includes, for example, a coolant pump, a valve, and a tube member for connecting the coolant pump and the valve to each other. In the case where the coolant pump and the valve are connected by the tube member, the size of the cooling device tends to increase. Further, since the number of components of the cooling device increases, the number of steps of assembling the fuel cell device tends to increase. According to the present disclosure, it is possible to provide a fuel cell device in which the size of a cooling device can be reduced and the number of assembly steps can be reduced.

A fuel cell device 10 according to an embodiment of the present disclosure will be described below with reference to the drawings. The fuel cell device 10 can be mounted on a vehicle (not shown) such as a fuel cell electric vehicle. The fuel cell device 10 may be mounted on a stationary power generation system or the like.

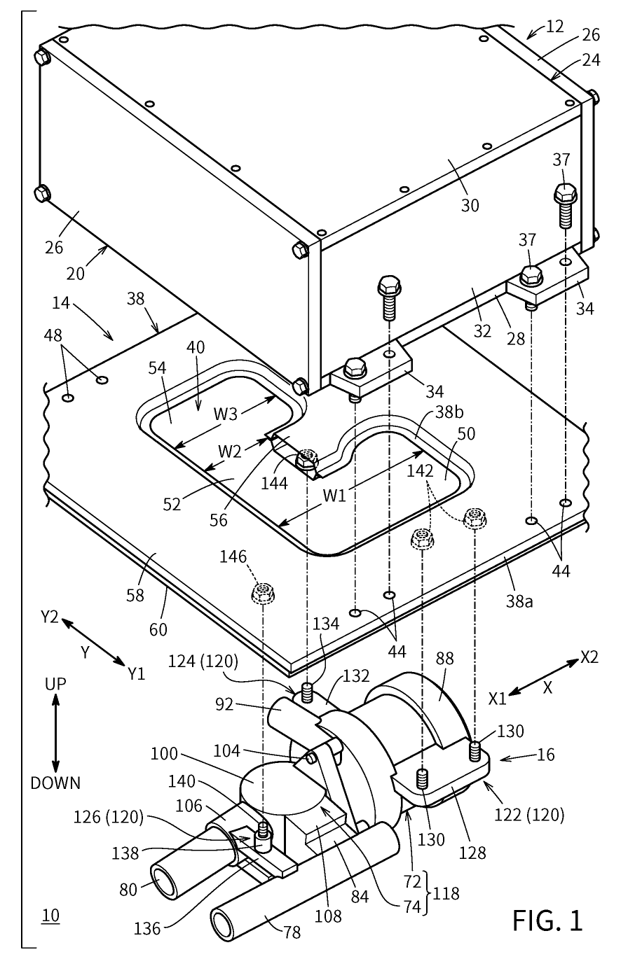

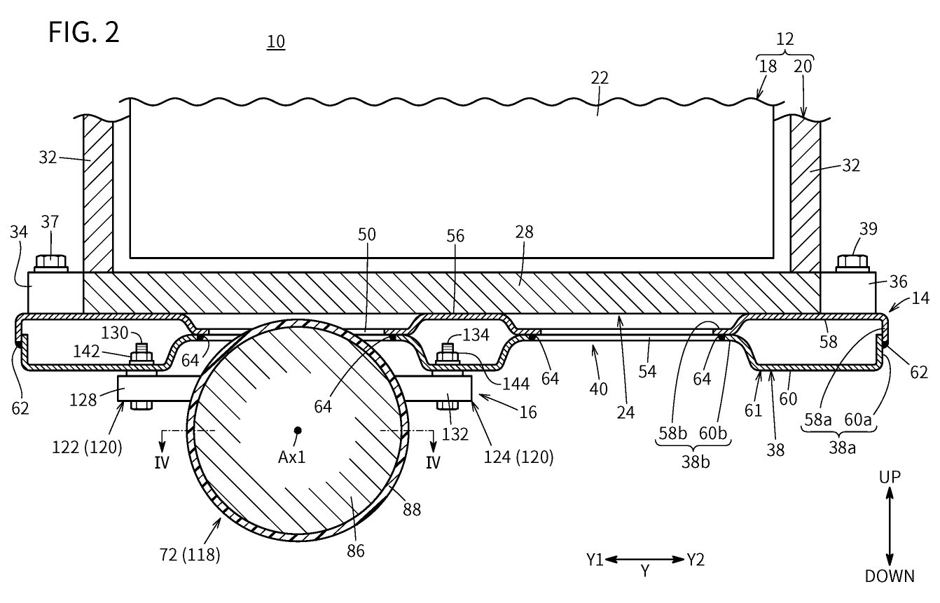

As shown in FIG. 1, the fuel cell device 10 includes a fuel cell stack 12, a support member (a support frame) 14, and a cooling device 16. As shown in FIGS. 1 and 2, the fuel cell stack 12 includes a fuel cell body 18 and a stack case 20. The fuel cell body 18 is formed by stacking a plurality of power generation cells 22. In the present embodiment, the plurality of power generation cells 22 are stacked in an X direction. Note that, in the following description, a direction orthogonal to the X direction and the up-down direction may be referred to as a Y direction. The power generation cells 22 generate electric power by an electrochemical reaction between a fuel gas and an oxygen-containing gas.

The stack case 20 accommodates the fuel cell body 18. The stack case 20 includes a peripheral wall case 24 and a pair of end plates 26. The peripheral wall case 24 is formed in a quadrangular tubular shape. The peripheral wall case 24 includes a lower plate 28, an upper plate 30, and a pair of side plates 32.

A pair of leg portions 34 are provided at one end portion of the lower plate 28 in the Y direction (an end portion of the lower plate 28 in a Y1 direction). The pair of leg portions 34 are separated from each other in the X direction. A pair of leg portions 36 are provided at the other end portion of the lower plate 28 in the Y direction (an end portion of the lower plate 28 in a Y2 direction). The pair of leg portions 36 are separated from each other in the X direction.

The support member 14 supports the fuel cell stack 12, and a coolant pump 72 of the cooling device 16. The fuel cell stack 12 is disposed above the support member 14, and the coolant pump 72 is disposed below the support member 14. As a result, the fuel cell device 10 can be made compact.

The support member 14 can be attached to, for example, a vehicle body frame (not shown). The support member 14 includes a support plate unit 38. The fuel cell stack 12 is disposed on an upper surface of the support plate unit 38.

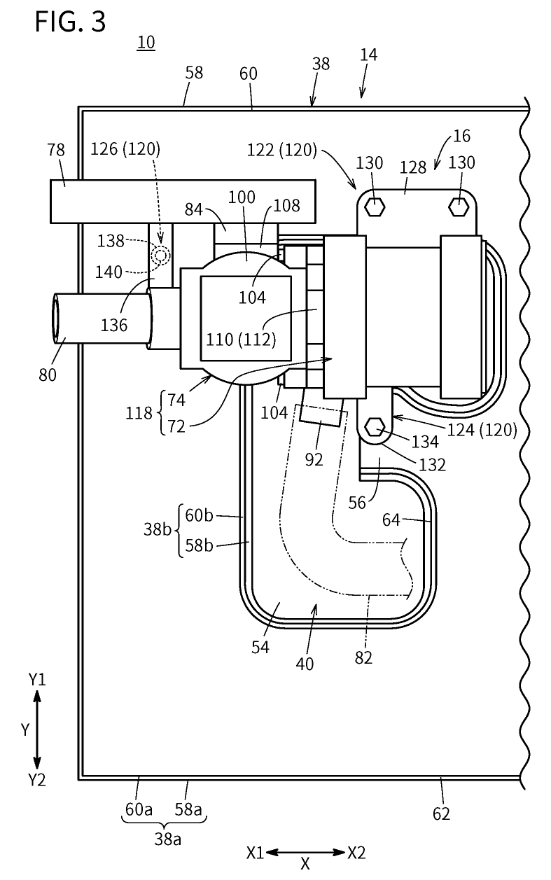

As shown in FIGS. 1 and 3, the support plate unit 38 is formed in an annular shape. A cutout portion 40 penetrating the support plate unit 38 in the up-down direction is formed in the central portion of the support plate unit 38. An outer peripheral edge portion 38a of the support plate unit 38 is formed in a quadrangular shape when viewed from above.

A plurality of attachment holes 44 through which bolts 37 for fixing the pair of leg portions 34 are passed are formed in a portion, which is located on the Y1 direction side, of the outer peripheral edge portion 38a of the support plate unit 38. A plurality of attachment holes 48 through which bolts 39 for fixing the pair of leg portions 36 (see FIG. 2) are passed are formed in a portion, which is located on the Y2 direction side, of the outer peripheral edge portion 38a of the support plate unit 38.

The cutout portion 40 includes a first hole portion 50, a second hole portion 52, and a third hole portion 54. The first hole portion 50 is located further in the Y1 direction than the central portion of the support plate unit 38 in the Y direction. The second hole portion 52 extends in the Y2 direction from the first hole portion 50. The third hole portion 54 is connected to an end of the second hole portion 52 in the Y2 direction. A width W1 of the first hole portion 50 in the X direction is greater than a width W2 of the second hole portion 52 in the X direction. A width W3 of the third hole portion 54 in the X direction is smaller than the width W1 of the first hole portion 50 and greater than the width W2 of the second hole portion 52.

The support plate unit 38 includes an intermediate support portion 56 that separates the first hole portion 50 and the third hole portion 54 from each other. The intermediate support portion 56 extends in the X direction. The second hole portion 52 is located on an X1 direction side of the intermediate support portion 56.

As shown in FIG. 2, the support plate unit 38 includes a hollow cross-sectional structure portion 61 including an upper metal plate 58 and a lower metal plate 60. This makes it possible to increase the rigidity of the support plate unit 38 while reducing the weight of the support plate unit 38. Each of the upper metal plate 58 and the lower metal plate 60 is, for example, a steel plate, but is not limited thereto.

An outer peripheral edge portion 58a of the upper metal plate 58 and an outer peripheral edge portion 60a of the lower metal plate 60 overlap each other. The outer peripheral edge portion 58a of the upper metal plate 58 and the outer peripheral edge portion 60a of the lower metal plate 60 are joined to each other by a joint portion 62 (hereinafter, may be referred to as an "outer peripheral joint portion 62"). In other words, the outer peripheral joint portion 62 is provided on the outer peripheral edge portion 38a of the support plate unit 38. The outer peripheral joint portion 62 extends in a quadrangular shape along the outer peripheral edge portion 38a of the support plate unit 38. The outer peripheral joint portion 62 is not limited to the example in which it extends in a quadrangular shape, and may be intermittently provided on the outer peripheral edge portion 38a of the support plate unit 38.

An inner peripheral edge portion 58b of the upper metal plate 58 that forms the cutout portion 40 and an inner peripheral edge portion 60b of the lower metal plate 60 that forms the cutout portion 40 overlap each other. The inner peripheral edge portion 58b of the upper metal plate 58 and the inner peripheral edge portion 60b of the lower metal plate 60 are joined to each other by a joint portion 64 (hereinafter, may be referred to as an "inner peripheral joint portion 64"). In other words, the inner peripheral joint portion 64 is provided on an inner peripheral edge portion 38b of the support plate unit 38. The inner peripheral joint portion 64 extends along the outer shape of the cutout portion 40. This makes it possible to increase the rigidity of the inner peripheral edge portion 38b of the support plate unit 38. The inner peripheral joint portion 64 may be intermittently provided on the inner peripheral edge portion 38b of the support plate unit 38.

Each of the outer peripheral joint portion 62 and the inner peripheral joint portion 64 is, for example, a welded portion formed by welding together the upper metal plate 58 and the lower metal plate 60. Such a welded portion can be formed by, for example, laser welding, TIG welding, MIG welding, or the like. Each of the outer peripheral joint portion 62 and the inner peripheral joint portion 64 is not limited to a welded portion, and may be formed by, for example, friction stir welding.

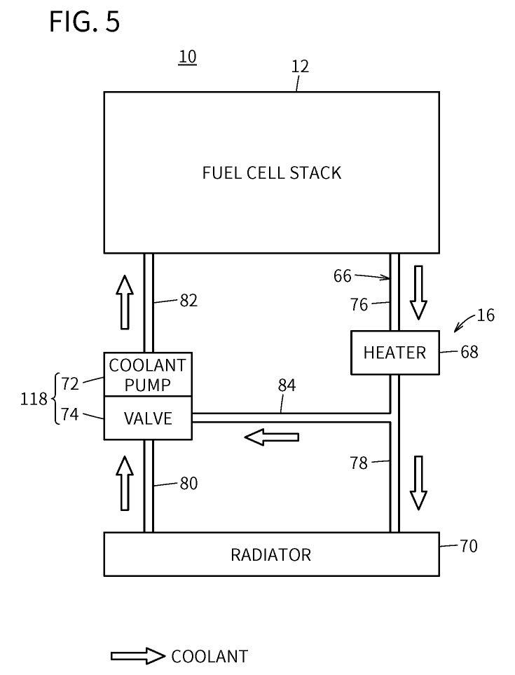

As shown in FIG. 5, the cooling device 16 includes a coolant pipe 66, a heater 68, a radiator 70, the coolant pump 72, and a valve 74. Although other constituent elements may be included in the cooling device 16 apart from these constituent elements, description of such elements will be omitted herein. The coolant pipe 66 forms a flow path for circulating the coolant through the fuel cell stack 12. As the coolant (cooling medium), for example, pure water can be used. The coolant may contain, for example, ethylene glycol.

The coolant pipe 66 includes a coolant discharge pipe portion 76, a radiator introduction pipe portion 78, a radiator lead-out pipe portion 80, a coolant supply pipe portion 82, and a bypass pipe portion 84. The coolant discharge pipe portion 76 connects the fuel cell stack 12 and the heater 68. The coolant discharge pipe portion 76 guides, to the heater 68, the coolant discharged from the fuel cell stack 12. The radiator introduction pipe portion 78 connects the heater 68 and the radiator 70. The radiator introduction pipe portion 78 guides, to the radiator 70, the coolant that has flowed through the heater 68. The radiator lead-out pipe portion 80 connects the radiator 70 and the valve 74. The radiator lead-out pipe portion 80 guides, to the valve 74, the coolant that has flowed through the radiator 70.

The coolant supply pipe portion 82 connects the coolant pump 72 and the fuel cell stack 12. The coolant supply pipe portion 82 guides, to the fuel cell stack 12, the coolant that has flowed from the valve 74 to the coolant pump 72. The bypass pipe portion 84 connects the radiator introduction pipe portion 78 and the valve 74. The bypass pipe portion 84 is disposed so as to bypass the radiator 70. The bypass pipe portion 84 guides, to the valve 74, the coolant that has flowed through the heater 68.

The heater 68 warms the coolant. The radiator 70 cools the coolant. The coolant pump 72 discharges the coolant toward the fuel cell stack 12. The coolant pump 72 may be, for example, a centrifugal pump, but is not limited thereto.

As shown in FIGS. 1 and 2, the coolant pump 72 is located below the fuel cell stack 12. The coolant pump 72 is attached to a lower surface of the support member 14. At least a part of the coolant pump 72 is located in the cutout portion 40 (the first hole portion 50) in a state of being attached to the support member 14 (see FIG. 2). This makes it possible to reduce the height of the fuel cell device 10.

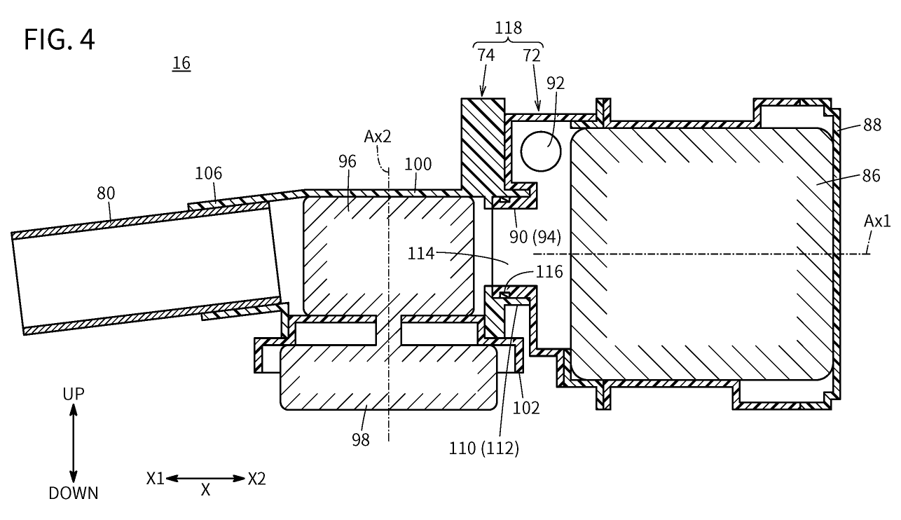

As shown in FIG. 4, a rotational axis Ax1 of the coolant pump 72 extends along the X direction. The coolant pump 72 includes a pump main body 86, a pump case 88, a first pump port portion 90, and a second pump port portion 92. The pump main body 86 may include, for example, an impeller. The pump case 88 accommodates the pump main body 86. The pump case 88 is made of, for example, a resin material. The pump case 88 is formed in a circular shape when viewed from an X2 direction (see FIG. 2).

The first pump port portion 90 protrudes in the X1 direction from the pump case 88. The first pump port portion 90 is a first connection pipe portion 94. The first connection pipe portion 94 can cause the coolant to flow into the pump case 88. The center line of the first connection pipe portion 94 is located on an extension line of the rotational axis Ax1 of the coolant pump 72. As shown in FIGS. 1, 3, and 4, the second pump port portion 92 protrudes in the Y2 direction from the pump case 88. The coolant can be discharged through the second pump port portion 92. The coolant supply pipe portion 82 is connected to the second pump port portion 92 (see FIG. 3).

The valve 74 is, for example, a flow path switching valve (three way valve). The valve 74 is adjacent to the coolant pump 72 in the X1 direction. The valve 74 includes a valve main body (a valve element) 96, a valve drive portion 98, a valve case 100, and a drive support portion 102. The valve main body 96 is provided in the valve case 100 so as to be rotatable about a rotational axis Ax2 extending in the up-down direction, for example. The valve drive portion 98 can rotate the valve 74.

The valve case 100 is made of, for example, a resin material. The valve case 100 accommodates the valve main body 96. The valve case 100 is attached to the pump case 88 by a plurality of bolts 104 (see FIGS. 1 and 3). The drive support portion 102 supports the valve drive portion 98. The drive support portion 102 is attached to the valve case 100 by a bolt (not shown).

As shown in FIGS. 1 and 3, the valve case 100 is provided with a first valve port portion 106, a second valve port portion 108, and a third valve port portion 110. The first valve port portion 106 protrudes in the X1 direction from the valve case 100. The radiator lead-out pipe portion 80 is connected to the first valve port portion 106. The second valve port portion 108 protrudes in the Y1 direction from the valve case 100. The bypass pipe portion 84 is connected to the second valve port portion 108.

As shown in FIG. 4, the third valve port portion 110 protrudes in the X2 direction from the valve case 100. The third valve port portion 110 is a second connection pipe portion 112 directly connected to the first connection pipe portion 94 of the coolant pump 72.

The second connection pipe portion 112 is fitted to the first connection pipe portion 94. As a result, the connecting portion between the coolant pump 72 and the valve 74 can be made compact. Specifically, the first connection pipe portion 94 is fitted into the second connection pipe portion 112. A coolant flow path 114 is formed by directly connecting the second connection pipe portion 112 to the first connection pipe portion 94. A seal member 116 for preventing the coolant from leaking to the outside is provided between an outer peripheral surface of the first connection pipe portion 94 and an inner peripheral surface of the second connection pipe portion 112. The second connection pipe portion 112 may be fitted into the first connection pipe portion 94.

The coolant pump 72 and the valve 74 are formed as one unit (a pump-valve unit) 118. In this case, the unit 118 can be easily attached to the support member 14 as compared to a case where the coolant pump 72 and the valve 74 are separately attached to the support member 14.

As shown in FIG. 1, the unit 118 is provided with a plurality of attachment portions 120. The plurality of attachment portions 120 are located at the same height. The plurality of attachment portions 120 are located above the rotational axis Ax1 of the coolant pump 72 (see FIG. 2). The plurality of attachment portions 120 include a first attachment portion 122, a second attachment portion 124, and a third attachment portion 126.

As shown in FIGS. 1 and 2, the first attachment portion 122 protrudes in the Y1 direction from the pump case 88. The first attachment portion 122 includes a first plate-shaped portion 128 and two first bolts 130. The second attachment portion 124 protrudes in the Y2 direction from the pump case 88. The second attachment portion 124 includes a second plate-shaped portion 132 and one second bolt 134.

As shown in FIG. 1, the third attachment portion 126 includes a third plate-shaped portion 136, a support tube portion 138, and a third bolt 140. The third plate-shaped portion 136 is attached to the first valve port portion 106 and the radiator introduction pipe portion 78 by bolts or the like (not shown). The support tube portion 138 is fixed to the third plate-shaped portion 136. An upper end surface of the support tube portion 138 is in contact with the lower surface of the support member 14. The third bolt 140 is inserted through the interior of the support tube portion 138.

A pair of first nut portions (first attached portions) 142 are provided on a portion, which is located on the Y1 direction side of the first hole portion 50, of the inner peripheral edge portion 38b of the support plate unit 38. The pair of first nut portions 142 are disposed apart from each other in the X direction. Each first nut portion 142 is adjacent to the inner peripheral joint portion 64. Each first nut portion 142 is fixed to an upper surface of the lower metal plate 60. A pair of first bolts 130 are fastened to the pair of first nut portions 142, respectively.

A second nut portion (a second attached portion) 144 is provided on a portion (the intermediate support portion 56), which is located on the Y2 direction side of the first hole portion 50, of the inner peripheral edge portion 38b of the support plate unit 38. The second nut portion 144 is adjacent to the inner peripheral joint portion 64. The second nut portion 144 is fixed to the upper surface of the lower metal plate 60. A second bolt 134 is fastened to the second nut portion 144.

Since the coolant pump 72 is attached to the support plate unit 38 at locations (the first nut portions 142 and the second nut portion 144) each adjacent to the inner peripheral joint portion 64, the coolant pump 72 can be stably supported by the support plate unit 38.

A third nut portion (a third attached portion) 146 is provided on a portion of the support plate unit 38 that is located on the X1 direction side of the first hole portion 50. The third nut portion 146 is fixed to the upper surface of the lower metal plate 60. The third bolt 140 is fastened to the third nut portion 146. This allows the valve 74 to be fixed to the support plate unit 38.

According to the present embodiment, since the second connection pipe portion 112 is directly connected to the first connection pipe portion 94, a tube member for connecting the coolant pump 72 and the valve 74 is not required. This makes it possible to reduce the size of the cooling device 16 and reduce the number of steps of assembling the fuel cell device 10. Further, since the first connection pipe portion 94 protrudes from the pump case 88, the rigidity of the pump case 88 can be increased. Therefore, pulsations that may occur when the coolant pump 72 is driven can be suppressed.

The following supplementary notes are further disclosed in relation to the above-described embodiment.

### Supplementary Note 1

The fuel cell device (10) of the present disclosure includes the cooling device (16) configured to circulate the coolant through the fuel cell stack (12), wherein the cooling device includes: the coolant pump (72) including the pump case (88) configured to cover the pump main body (86), and the first connection pipe portion (94) protruding from the pump case; and the valve (74) including the valve case (100) configured to cover the valve main body (96), and the second connection pipe portion (112) protruding from the valve case, and the coolant flow path (114) is formed by directly connecting the second connection pipe portion to the first connection pipe portion.

According to such a configuration, since the second connection pipe portion is directly connected to the first connection pipe portion, a tube member for connecting the coolant pump and the valve is not required. This makes it possible to reduce the size of the cooling device and reduce the number of steps of assembling the fuel cell device. Further, since the first connection pipe portion protrudes from the pump case, the rigidity of the pump case can be increased. Therefore, pulsations that may occur when the coolant pump is driven can be suppressed.

### Supplementary Note 2

The fuel cell device according to Supplementary Note 1 may further include the support member (14) configured to support the fuel cell stack and the coolant pump, wherein the fuel cell stack may be disposed above the support member, and the coolant pump may be disposed below the support member.

According to such a configuration, the fuel cell device can be made compact.

### Supplementary Note 3

In the fuel cell device according to Supplementary Note 2, the support member may include the support plate unit (38), the cutout portion (40) penetrating the support plate unit in the up-down direction may be formed in the support plate unit, and at least a part of the coolant pump may be located in the cutout portion.

According to this configuration, the height of the fuel cell device can be reduced.

### Supplementary Note 4

In the fuel cell device according to Supplementary Note 3, the support plate unit may include the hollow cross-sectional structure portion (61) including the upper metal plate (58) and the lower metal plate (60), the joint portion (64) at which the upper metal plate and the lower metal plate are joined to each other may be provided on the edge portion (38b) of the support plate unit, the edge portion forming the cutout portion, and the pump case may be attached to a location on the support plate unit, the location being adjacent to the joint portion.

According to such a configuration, since the support plate unit includes the hollow cross-sectional structure portion, the rigidity of the support plate unit can be increased while reducing the weight of the support plate unit. Further, by providing the joint portion on the edge portion forming the cutout portion, the rigidity of the edge portion can be increased. Furthermore, since the coolant pump is attached to the location adjacent to the joint portion, the coolant pump can be stably supported by the support plate unit.

### Supplementary Note 5

In the fuel cell device according to any one of Supplementary Notes 1 to 4, the second connection pipe portion may be fitted to the first connection pipe portion.

According to such a configuration, the connecting portion between the coolant pump and the valve can be made compact.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A fuel cell device comprising a cooling device configured to circulate a coolant through a fuel cell stack,
wherein the cooling device includes:
a coolant pump including a pump case configured to cover a pump main body, and a first connection pipe portion protruding from the pump case; and
a valve including a valve case configured to cover a valve main body, and a second connection pipe portion protruding from the valve case, and
a coolant flow path is formed by directly connecting the second connection pipe portion to the first connection pipe portion.

2. The fuel cell device according to claim 1, further comprising a support member configured to support the fuel cell stack and the coolant pump, wherein
the fuel cell stack is disposed above the support member, and
the coolant pump is disposed below the support member.

3. The fuel cell device according to claim 2, wherein
the support member includes a support plate unit,
a cutout portion penetrating the support plate unit in an up-down direction is formed in the support plate unit, and
at least a part of the coolant pump is located in the cutout portion.

4. The fuel cell device according to claim 3, wherein
the support plate unit includes a hollow cross-sectional structure portion including an upper metal plate and a lower metal plate,
a joint portion at which the upper metal plate and the lower metal plate are joined to each other is provided on an edge portion of the support plate unit, the edge portion forming the cutout portion, and
the pump case is attached to a location on the support plate unit, the location being adjacent to the joint portion.

5. The fuel cell device according to claim 1, wherein
the second connection pipe portion is fitted to the first connection pipe portion.
